(19) United States
(12) Patent Application Publication
(10) Pub. No.: US 2011/0038313 A1
(43) Pub. Date: Feb. 17, 2011

(54) ENHANCED COMMUNICATION APPARATUS FOR PROVIDING ENHANCED CONCATENATION, SEGMENTATION AND REASSEMBLY OF SERVICE DATA UNITS

(75) Inventors: Hyun Seo Park, Daejeon (KR); Changki Kim, Daejeon (KR); Kyung Sook Kim, Daejeon (KR); Jae Sheung Shin, Daejeon (KR); Pyeong Jung Song, Daejeon (KR); Yeon Seung Shin, Daejeon (KR)

Correspondence Address: NELSON MULLINS RILEY & SCARBOROUGH LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/855,239

(22) Filed: Aug. 12, 2010

(30) Foreign Application Priority Data
Aug. 12, 2009 (KR) 10-2009-0074186
Jun. 1, 2010 (KR) 10-2010-0051676

(51) Int. Cl. H04W 72/00

(52) U.S. Cl. 370/328

(57) ABSTRACT

Provided is an enhanced communication apparatus. The enhanced communication apparatus may enable a Packet Data Convergence Protocol (PDCP) layer unit to perform a part of a concatenation function, a segmentation function, and a reassembly function of a Radio Link Control (RLC) layer unit that is a sublayer of Layer 2, and may decrease a number of Packet Data Convergence Protocol Packet Data Units (PDCP PDUs) to be processed by the RLC layer unit.

### CROSS-REFERENCE TO RELATED APPLICATION(S)

This application claims the benefit of Korean Patent Application Nos. 10-2009-0074186 and 10-2010-0051676, respectively filed on Aug. 12, 2009 and Jun. 1, 2010, in the Korean Intellectual Property Office, the disclosures of which are incorporated herein by references.

### BACKGROUND

1. Field of the Invention

The present invention relates to a Long Term Evolution (LTE)-affiliated communication, such as a LTE communication, a LTE-Advanced communication, and the like, and more particularly, to a concatenation function, a segmentation function, and a reassembly function with respect to a service data unit (SDU).

2. Description of the Related Art

In a Long Term Evolution (LTE)-affiliated communication, such as an LTE communication, an LTE advanced communication, and the like, Layer 2 of a terminal and Layer 2 of a base station may be constituted by three sublayer including a packet data convergence protocol (PDCP) layer, a radio link control (RLC) layer, and a medium access control (MAC) layer. An apparatus performing the LTE-affiliated communication, such as the LTE communication, the LTE-advanced communication, and the like, may be referred to as an LTE communication apparatus. The LTE communication apparatus may include an apparatus performing a partially modulated communication that is based on the LTE communication, in addition to the LTE communication and the LTE-advanced communication.

In a conventional LTE-affiliated communication system, an RLC layer performs concatenation, segmentation, and reassembly with respect to RLC SDUs, i.e. Packet Data Convergence Protocol Packet Data Units (PDCP PDUs), based on scheduling information determined based on a radio link state. Although a number of requests for a high-speed data transport increases, a maximum transmission unit may be slightly changed, for example, by about 1500 bytes. Therefore, when a high-speed data transport is performed in the LTE-affiliated communication system, a number of Packet Data Convergence Protocol Service Data Units (PDCP SDUs) may increase. Accordingly, a number of PDCP PDUs to be processed by the RLC layer unit increases and thus, the RLC may have a difficulty in concatenating, segmenting, and reassembling PDUs during a predetermined time.

### SUMMARY

An aspect of the present invention provides a method of decreasing a number of Packet Data Convergence Protocol Packet Data Units (PDCP PDUs) to be processed by a Radio Link Control (RLC) layer that is one of a sublayer of Layer 2 of a Long Term Evolution (LTE) communication apparatus, thereby enabling concatenation, segmentation, and reassembly to be performed with respect to a Service Data Unit (SDU) during a predetermined time.

Another aspect of the present invention also provides an LTE communication apparatus that may decrease a number of PDCP PDUs to be processed by an RLC layer and may maintain a backward compatibility with a conventional LTE communication apparatus.

According to an aspect of the present invention, there may be provided an enhanced LTE communication apparatus including a Packet Data Convergence Protocol (PDCP) layer unit to concatenate a plurality of Packet Data Convergence Protocol Service Data Units (PDCP SDUs) to generate at least one PDCP PDU, and an RLC layer unit to concatenate or segment the at least one PDCP PDU received from the PDCP layer unit. The PDCP layer unit may concatenate the plurality of PDCP SDUs based on a radio link state to generate the at least one PDCP PDU. The PDCP layer unit concatenates the plurality of PDCP SDUs based on a transmission period of an MAC layer unit.

According to an aspect of the present invention, there may be provided an enhanced LTE communication apparatus including an RLC layer unit to reassemble a plurality of PDUs received from a Physical Layer (PHY) to generate at least one reassembled PDU, and a PDCP layer unit to separate the at least one reassembled PDU received from the RLC layer unit.

According to an aspect of the present invention, a PDCP PDU may include, subsequent to octet including a PDCP SN field, a field indicating a length of each PDCP SDU, and a bit indicating whether each PDCP SDU of a concatenated plurality of PDCP SDUs has a subsequently concatenated PDCP SDU. The PDCP PDU may include, in a fourth bit of octet 1, a bit indicating whether the concatenated plurality of PDCP SDUs exists.

Additional aspects, features, or advantages of the invention will be set forth in part in the description which follows and, in part, will be apparent from the description, or may be learned by practice of the invention.

### EFFECT

According to embodiments, a number of Packet Data Convergence Protocol Packet Data Units (PDCP PDUs) to be processed by a Radio Link Control (RLC) layer unit that is a sublayer of Layer 2 of a Long Term Evolution (LTE) communication apparatus may decrease.

According to embodiments, a number of PDCP PDUs to be processed by an RLC layer unit may decrease and thus, the RLC layer unit may easily process concatenation, segmentation, and reassembly with respect to a PDU during a predetermined time.

According to embodiments, a number of PDCP PDUs to be processed by an RLC layer unit may decrease and a backward compatibility may be maintained.

### BRIEF DESCRIPTION OF THE DRAWINGS

These or other aspects, features, and advantages of the invention will become apparent and more readily appreciated from the following description of embodiments, taken in conjunction with the accompanying drawings of which:

FIG. 1 is a diagram illustrating Layer 1 and Layer 2 of a Long Term Evolution (LTE) communication apparatus according to an embodiment of the present invention;

FIG. 2 is a diagram illustrating an operation of a transmitting part of an LTE communication apparatus according to an embodiment of the present invention;

FIG. 3 is a diagram illustrating a Packet Data Convergence Protocol Packet Data Unit (PDCP PDU) according to an embodiment of the present invention; and

FIG. 4 is a diagram illustrating an operation of receiving part of an LTE communication apparatus according to an embodiment of the present invention.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

Throughout the specification, a base station may be defined to include various apparatuses for transmitting a signal to a terminal, such as a general base station, a relay station, and the like, and a terminal may be defined to include various mobile devices such as a cellular phone and a laptop. The communication apparatus may be defined to include various apparatuses used in a communication system, such as a base station, a relay station, a terminal, a network controller, and the like. A Long Term Evolution (LTE) communication apparatus may be defined to include an apparatus for performing a partially modulated communication that is based on the LTE communication, in addition to a currently known apparatus of performing an LTE-affiliated communication, such as the LTE communication and the LTE-advanced communication.

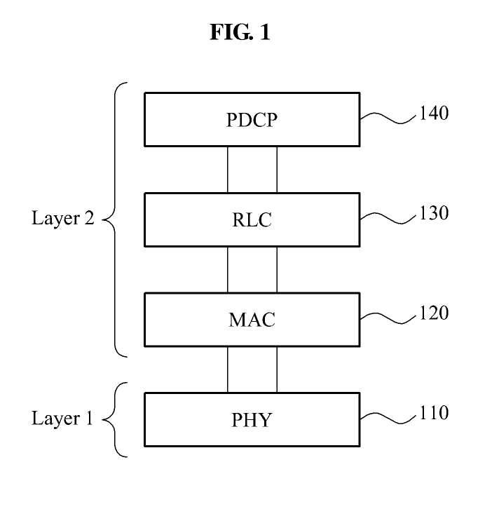

FIG. 1 illustrates Layer 1 and Layer 2 of an enhanced LTE communication apparatus according to an embodiment of the present invention.

The Layer 1 and the Layer 2 of FIG. 1 may have the same structure that may be used for a transmission and reception procedure using the enhanced LTE communication apparatus.

The Layer 1 of the enhanced LTE communication apparatus may be constituted of a PHY layer unit 110. The PHY layer unit 110 may adopt an orthogonal frequency division multiplexing (OFDM) data transport scheme and a multiple input multiple output (MIMO) data transport scheme to satisfy carrier requirements for a high-speed data transport and a high-capacity voice support. The PHY layer unit 110 may use an orthogonal frequency division multiplexing access (OFDMA) in a downlink. The PHY layer unit 110 may use a single carrier-frequency division multiple access (SC-FDMA) in an uplink.

The Layer 2 of the enhanced LTE communication apparatus may include three sub layers, such as a medium access control (MAC) layer unit 120, a radio link control (RLC) layer unit 130, and a packet data convergence protocol (PDCP) layer unit 140. The PDCP layer unit 140 may perform a part of a concatenation function, a segmentation function, and a reassembly function of the RLC layer unit 130 with respect to a PDU, to reduce a number of Packet Data Convergence Protocol Packet Data Units (PDCP PDUs) to be processed by the RLC layer unit 130 that is a sublayer of the Layer 2.

The PDCP layer unit 140 may concatenate a plurality of Packet Data Convergence Protocol Service Data Units (PDCP SDUs) received from Layer 3 to generate at least one PDP PDU. In a conventional LTE communication system, a PDCP layer unit may not perform the concatenation of PDCP SDUs and an RLC layer unit may perform the concatenation of the PDCP SDUs. Although a number of requests for a high-speed data transport increases, a maximum transmission unit (MTU) may be slightly changed, for example, by about 1500 bytes. Therefore, when the high-speed data transport is performed in the convention LTE communication system, a number of the PDCP SDUs increases. Accordingly, the number of PDCP PDUs to be processed by the RLC layer unit increases and thus, the RLC layer unit may have a difficulty in concatenating PDUs during a predetermined time. However, the PDCP layer unit 140 may concatenate the plurality of PDCP SDUs received from the Layer 3. The PDCP layer unit 140 may concatenate the plurality of PDCP SDUs received from the Layer 3 to generate the at least one PDCP PDU and may transport the at least one PDCP PDU to the RLC layer unit 130.

According to an embodiment, the PDCP layer unit 140 may perform the concatenation with respect to the PDCP SDUs based on a radio link state. Information associated with the radio link state may be transmitted, from the MAC layer unit 120, to the PDCP layer unit 140. The MAC layer unit 120 may manage scheduling information determined based on the radio link state. The MAC layer unit 120 may transmit the scheduling information to the PDCP layer unit 140 and the PDCP layer unit 140 may perform the concatenation based on the scheduling information. For example, the PDCP layer unit 140 may concatenate a relatively greater number of PDCP SDUs to generate a single PDU when the radio link state is good, and the PDCP layer unit 140 may concatenate a relatively smaller number of PDCP SDUs to generate a single PDU when the radio link state is not good. In this case, the PDCP layer unit 140 may be aware of the scheduling information determined based on the radio link state, and the PDCP layer unit 140 may perform the concatenation of PDCP SDUs based on the scheduling information.

According to another embodiment, the PDCP layer unit 140 may perform the concatenation of PDCP SDUs based on a transmission period of the MAC layer unit 120. The PDCP layer unit 140 may perform the concatenation of PDCP SDUs based on the transmission period of the MAC layer unit 120 every time that the MAC layer unit 120 performs transmission, to generate at least one PDCP PDU. The generated at least one PDCP PDU may be transmitted to the RLC layer unit 130, and the RLC layer unit 130 may perform segmentation or reassembly based on the radio link state. The MAC layer unit 120 may maintain the scheduling information determined based on the radio link sate, and the RLC layer unit 130 may perform segmentation or reassembly with respect to the at least one PDCP PDU based on the scheduling information. The PDCP layer unit 140 may not need to be aware of the radio link state or the scheduling information. In a current LTE communication standard, a size of up to 2047 bytes of an RLC SDU may be supported, excluding a final SDU, and thus, the concatenation performed by the PDCP layer unit 140 may be limited.

Data received based on a radio link may be transmitted, via the PHY layer unit 110 and the MAC layer unit 120, to the RLC layer unit 130. The RLC layer unit 130 may receive a plurality of PDUs from the MAC layer unit 120. The RLC layer unit 130 may reassemble the plurality of received PDUs to generate at least one reassembled PDU. The reassembly performed by the RLC layer unit 130 of a receiving part may correspond to concatenation and/or segmentation performed by an RLC layer unit of the transmitting part.

The RLC layer unit 130 may transmit the reassembled PDU to the PDCP layer unit 140. The PDCP layer unit 140 may separate the reassembled PDU received from the RLC layer unit 130. The separation performed by the PDCP layer unit 140 of the receiving part may correspond to concatenation performed by a PDCP layer unit of the transmitting part.

The PDCP layer unit 140 may compress an IP header of an IP packet received from the Layer 3, and may generate a PDCP PDU based on the IP packet. The PDCP layer unit 140 may restore the IP packet and the IP header of the IP packet based on the PDCP PDU. The compression and decompression of the IP header may be performed by a robust header compression (RoHC) unit included in the PDCP layer unit 140. The PDCP layer unit 140 may perform security-processing to prevent a leakage of information included in the PDCP PDU. The PDCP layer unit 140 may encrypt the PDCP PDU. The PDCP layer unit 140 may perform in-sequence delivery of upper layer unit PDUs during a re-establishment procedure for a Radio Link Control Acknowledged Mode (RLC AM). The PDCP layer unit 140 may perform duplicate detection of lower layer unit SDUs during the re-establishment procedure for the RLC AM. The PDCP layer unit 140 may perform retransmission of PDCP SDUs during a handover for the RLC AM.

The RLC layer unit 130 may perform error correction using an automatic repeat request (ARQ). The RLC layer unit 130 may also perform protocol error detection and recovery, the duplication detection, and the like.

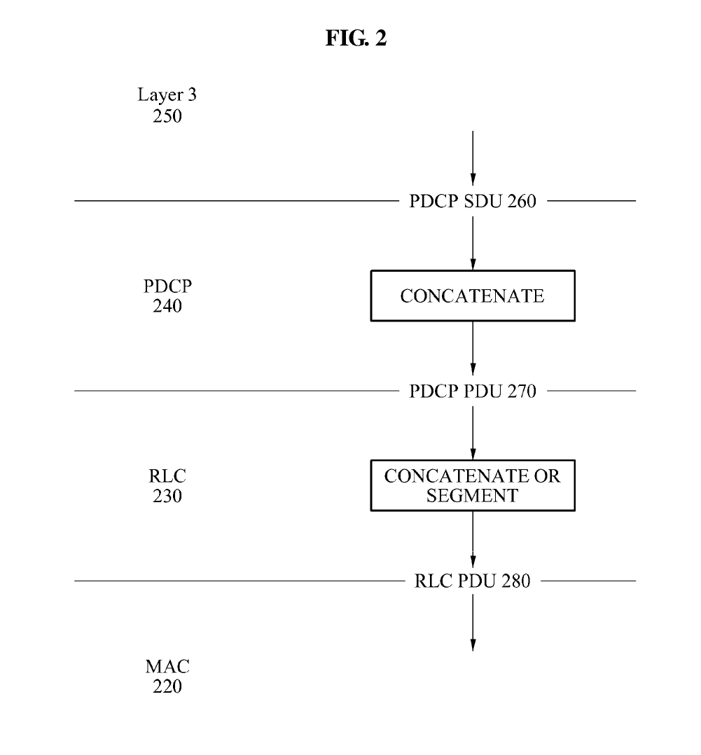

FIG. 2 illustrates an operation of a transmitting part of an LTE communication apparatus according to an embodiment of the present invention.

When a user transmits information using an LTE communication apparatus, the information may be transmitted to the Layer 3 250 via an upper layer unit of the LTE communication layer. A plurality of PDCP SDUs 260 may be transmitted to the PDCP layer unit 240 from the Layer 3 250.

The PDCP layer unit 240 may perform concatenation or segmentation with respect to the plurality of PDCP SDUs 260 received from the Layer 3 250 to generate at least one PDP PDU 270. According to an embodiment, the PDCP layer unit 240 may concatenate the plurality of PDCP SDUs 260 received from the Layer 3 250. The PDCP layer unit 240 may concatenate the plurality of PDCP SDUs 260 received from the Layer 3 250 to generate at least one PDCP PDU 270, and may transmit the at least one PDCP PDU 270 to the RLC layer unit 230.

According to an embodiment, the PDCP layer unit 240 may perform concatenation with respect to the plurality of PDCP SDUs 260 based on a radio link state. Information associated with the radio link state may be transmitted to the PDCP layer unit 240 from the MAC layer unit 220. The MAC layer unit 220 may manage scheduling information determined based on the radio link state. The MAC layer unit 220 may transmit the scheduling information to the PDCP layer unit 240, and the PDCP layer unit 240 may perform the concatenation based on the scheduling information. For example, the PDCP layer unit 240 may concatenate a relatively greater number of PDCP SDUs to generate a single PDU when the radio link state is good, and the PDCP layer unit 240 may concatenate a relatively smaller number of PDCP SDUs to generate a single PDU when the radio link state is not good.

According to another embodiment, the PDCP layer unit 240 may perform concatenation and/or segmentation with respect to the plurality of PDCP SDUs 260 based on the radio link state. The information associated with the radio link state may be transmitted, from the MAC layer unit 220, to the PDCP layer unit 240. The PDCP layer unit 240 may be aware of the scheduling information determined based on the radio link state, and the PDCP layer unit 240 may perform concatenation or segmentation with respect to a PDCP SDU. In this case, the RLC layer unit 230 may not need to perform segmentation and reassembly.

According to another embodiment, the PDCP layer unit 240 may concatenate the plurality of PDCP SDUs 260 based on a transmission period of the MAC layer unit 220. The PDCP layer unit 240 may concatenate the plurality of PDCP SDUs 260 based on a transmission period of the MAC layer unit 220 every time that the MAC layer unit 120 performs transmission, to generate the at least one PDCP PDU 270. For example, the PDCP layer unit 240 may concatenate the plurality of PDCP SDUs 260 to generate the at least one PDCP PDU 270 based on the period that the MAC layer unit 220 transmits data to a PHY layer unit (not illustrated). The MAC layer unit 220 may maintain the scheduling information determined based on the radio link state, and the RLC layer unit 230 may perform segmentation or reassembly with respect to the at least one PDCP PDU 270 based on the scheduling information. According to the present embodiment, the PDCP layer unit 240 may not need to be aware of the radio link state or the scheduling information.

The PDCP layer unit 240 may perform compression and decompression of a header and may perform security-processing.

The RLC layer unit 230 may perform protocol error detection and recovery, duplicate detection, ARQ, and the like. The RLC layer unit 230 may perform concatenation and/or segmentation with respect to the at least one PDCP PDU 270 received from the PDCP layer unit 240. When the at least one PDCP PDU 270 is received from the PDCP layer unit 230, the RLC layer unit 230 may store the received at least one PDCP PDU 270 in a transmission buffer. When the RLC layer unit 230 has a transmission chance and information associated with a size of data to be transmitted, the RLC layer unit 230 may perform, based on a transmission mode, concatenation and/or segmentation to generate an RLC PDU (not illustrated), and a size of the RLC PDU being the same as the size of the data. The generated RLC PDU may be transmitted to the MAC layer unit 220. A Transparent Mode (TM), Unacknowledged Mode (UM), and an Acknowledged Mode (AM) may be examples of the transmission mode.

The RLC layer unit 230 may manage the scheduling information determined based on the radio link state, and may perform concatenation and/or segmentation with respect to the at least one PDCP PDU 270 based on the radio link state. For example, when the radio link state is good, the RLC layer unit 240 may concatenate a relatively greater number of PDCP PDUs 270 to generate a single RLC PDU (not illustrated). Conversely, when the radio link state is not good, the RLC layer unit 240 may concatenate a relatively smaller number of PDCP PDUs 270 to generate a single RLC PDU (not illustrated) or may segment a PDCP PDU into a plurality of RLC PDU (not illustrated).

The MAC layer unit 220 may perform multiplexing and/or scheduling of the RLC PDU received from the RLC layer unit 230 and may transmit the multiplexed and/or scheduled the RLC PDU to the PHY layer unit.

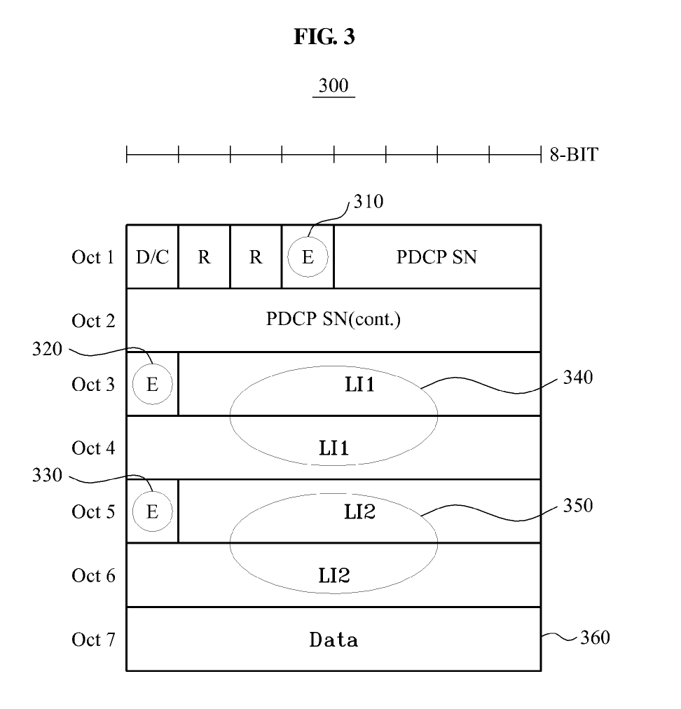

FIG. 3 illustrates a PDCP PDU 300 according to an embodiment of the present invention.

A format of the PDCP PDU may be newly defined to support embodiments. A format of the PDCP PDU of FIG. 3 may support the embodiments and may also maintain a backward compatibility.

Referring to FIG. 3, the PDCP PDU 300 may include, subsequent to octet including a PDCP SN field, E bits 320 and 330 and LI fields 340 and 350. The E bits 320 and 330 may indicate whether each PDCP SDU of a concatenated plurality of PDCP SDUs has a subsequently concatenated PDCP SDU. The LI fields 340 and 350 may store a length of each PDCP SDU. The PDCP PDU 300 may include, in a fourth bit of octet 1, an E bit 310 indicating whether the ‘concatenated plurality of PDCP SDUs’ exists.

For example, a PDCP layer unit may concatenate three PDCP SDUs received from Layer 3 to generate a single PDCP PDU 300. In this case, the E bit 310 may be set to ‘1’. An E bit 320 may be set to ‘1’, and a length of a first PDCP SDU included in the PDCP PDU 300 may be stored in an LI1 field 340. A number of concatenated PDCP SDUs included in the PDCP PDU 300 is three and thus, an E bit 330 may be set ‘0’. A length of a second PDCP SDU included in the PDCP PDU 300 may be stored in an LI2 field 350. The three PDCP SDUs may be concatenated and stored in a data field 360. The first PDCP SDU and the second PDCP SDU of the three PDCP SDUs stored in the data field 360 may be determined based on the LI1 field 340 and the LI2 field 350. For example, when a value in a field of the LI1 340 is 1000, up to 1000 bytes of data stored in the data field 360 may be the first PDCP SDU. The first PDCP SDU may be stored from octet 7, and the length of the first PDCP SDU may be stored in the LI1 field 340. The number of concatenated PDCP SDUs is three and thus, the second PDCP SDU concatenated to the first PDCP SDU may further exist. Accordingly, the E bit 320 may be set to ‘1’. The length of the second PDCP SDU may be stored in the LI2 field 350. Therefore, up to a location corresponding to a length value stored in the LI2 field 350 from a location corresponding to a length value stored in the LI1 field 340 in the data stored in the data field 340 may be the second PDCP SDU. For example, when the value in the LI1 field 340 is 1000 and a value in the LI2 field 350 is 900, a location corresponding to 1001 bytes through a location corresponding to 1900 bytes in data stored in the data field 360 may be the second PDCP SDU. The second PDCP SDU may be stored from a location corresponding to “Oct 7+value in the LI1 field 340”, and the length of the second PDCP SDU may be stored in the LI2 field 350. A subsequent PDCP SDU is a a final PDCP SDU and the E bit 330 may be set to ‘0’. A third PDCP SDU may be stored from a location subsequent to a location where the second PDCP SDU is stored. The third PDCP SDU may be stored from a location corresponding to ‘Oct 7+value in LI1 field+value in LI2 field’. A size of total PDU may be determined based on a size of an SDU of a sublayer and thus, an end of the third PDCP SDU may be determined.

A case where the PDCP layer unit may concatenate two PDCP SDUs received from the Layer 3 to generate a single PDCP PDU 300 is described below. In this case, the E bit 310 may be set to ‘1’. The E bit 320 may be set to ‘0’ and a length of a first PDCP SDU included in the PDCP PDU 300 may be stored in the LI1 field 340. The first PDCP SDU may be stored from octet 5, and the length of the first PDCP SDU may be stored in the LI1 field 340. A second PDCP SDU may be stored from a location corresponding to ‘Oct 5+value in LI1 field’.

When the PDCP layer unit does not perform concatenation, a single PDCP SDU may be a single PDCP PDU. In this case, the E bit 310 may be set to ‘0’, and the PDCP SDU may be stored from octet 3.

The present embodiment is one example and may be configured to be a different format, and still be within a scope of the principles and spirit of embodiments. For example, a format of the PDCP PDU may be designed to not have backward compatibility with a conventional LTE communication.

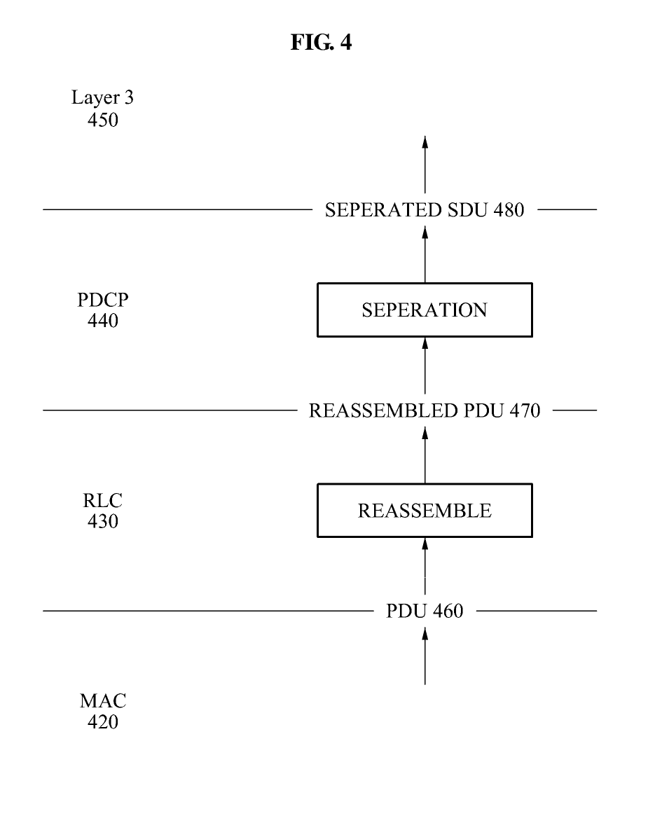

FIG. 4 illustrates an operation of receiving part of an LTE communication apparatus according to an embodiment of the present invention.

The MAC layer unit 420 may receive, from a PHY layer unit 420, data received based on a radio link. The MAC layer unit 420 may demultiplex the data received from the PHY layer unit 420 and may transmit the demultiplexed data to the RLC layer unit 430.

The RLC layer unit 430 may receive a plurality of PDUs 460 from the MAC layer unit 420. The RLC layer unit 430 may reassemble the plurality of received PDUs 460 to generate at least one reassembled PDU 460. The reassembly performed by the RLC layer unit 430 of a receiving part may correspond to concatenation or segmentation performed by the RLC layer unit 430 of the transmitting part of FIG. 2. The PDU 460 that the RLC layer unit 430 of the receiving part receives from the MAC layer unit 430 may correspond to the RLC PDU 280 that the RLC layer unit 230 of the transmitting part of FIG. 2 transmits to the MAC layer unit 220. The reassembled PDU 470 that the RLC layer unit 430 transmits to the PDCP layer unit 440 may correspond to the PDCP PDU 270 that the RLC layer unit 230 of the transmitting part of FIG. 2 receives from the PDCP layer unit 240.

The PDCP layer unit 440 may perform separation with respect to the reassembled PDU 470 received from the RLC layer unit 430. The separation performed by the PDCP layer unit 440 of the receiving part may correspond to the concatenation performed by the PDCP layer unit 240 of the transmitting part. The reassembled PDU 470 that the PDCP layer unit 440 of the receiving part receives from the RLC layer unit 430 may correspond to the PDCP PDU 270 that the PDCP layer unit 240 of the transmitting part of FIG. 2 transmits to the RLC layer unit 230. The PDCP layer unit 440 may perform separation with respect to the reassembled PDU 470 received from the RLC layer unit 430 and may generate a separated SDU 480. The separated SDU 480 may be transmitted to the Layer 3 450. The separated SDU 480 that the PDCP layer unit 440 of the receiving part transmits to the Layer 3 450 corresponds to the PDCP SDU 260 that the PDCP layer unit 240 of the transmitting part of FIG. 2 receives from the Layer 3 250.

The reassembled PDU 470 may include, in a fourth bit of octet 1, a bit indicating whether a ‘concatenated PDCP SDU’ exists. The reassembled PDU 470 may include, subsequent to an octet including a PDCP SN field, a field indicating a length of each PDCP SDU and a bit indicating whether each PDCP SDU of a plurality of concatenated PDCP SDU has a subsequently concatenated PDCP SDU. The PDCP layer unit 440 may separate the reassembled PDU 470 based on the bit indicating whether each PDCP SDU of the concatenated plurality of PDCP SDUs has the subsequently concatenated PDCP SDU, the field indicating the length of each PDCP SDU, and the bit indicating whether the concatenated PDCP SDU exists.

A procedure that the PDCP layer unit 440 separates the reassembled PDU 470 may be described with reference to FIG. 3. The PDCP layer unit 240 of the transmitting part of FIG. 2 concatenate three PDCP SDU 260 received from the Layer 3 250 to generate the single PDCP PDU 270, and FIG. 3 illustrates the PDCP PDU 270. As described above, the PDCP PDU 270 of the transmitting part may correspond to the reassembled PDU 470 of the receiving part.

The PDCP layer unit 440 of the receiving part may check a fourth bit 310 of octet 1 of the reassembled PDU 470. When the E bit 310 is set to ‘0’, a number of PDCP SDUs included in the reassembled PDU 470 is one and thus, the PDCP layer unit 440 may not perform the separation. A single PDCP SDU may be a single PDCP PDU. In this case, the PDCP layer unit 440 may read data from octet 3, and the data may be determined as the PDCP SDU. A size of a total PDU may be determined based on a size of an SDU of a sublayer. In this case, the size of the total PDU may be a size of the PDCP SDU, since the number of the PDCP SDUs included in the reassembled PDU 470 is one.

When the E bit 310 is set to ‘1’, the number of PDCP SDUs included in the reassembled PDU 470 is greater than or equal to two. Therefore, the PDCP layer unit 440 may check the E bit 320. When the E bit 320 is set to ‘0’, no other PDCP SDU may exist in the reassembled PDU 470. Accordingly, the number of the PDCP SDUs included in the reassembled PDU 470 may be two. The PDCP layer unit 440 may read the LI1 field 340 to obtain a length of a first PDCP SDU. The PDCP layer unit 440 may read data from octet 5 to a location corresponding to the length of the first PDCP SDU, and may separate the data corresponding to the length of the first PDCP SDU to obtain a first separated SDU 480. The obtained separated SDU 480 may be transmitted to the Layer 3 450. A second PDCP SDU may be obtained by reading data from a location corresponding to ‘octet 5+value in the LI1 field’. The size of the total PDU may be determined based on the size of the SDU of the sublayer and thus, the second PDCP SDU may be data from the location corresponding to the ‘octet 5+value in the LI1 field’ to an end of the PDU. The separated second SDU 480 may also be transmitted to the Layer 3 450.

When the E bit 310 and the E bit 320 are set to ‘1’, the PDCP layer unit 440 may check the E bit 330. When the E bit 330 is set to ‘0’, no other PDCP SDU may exist in the reassembled PDU 470. Accordingly, the number of the PDCP SDUs included in the reassembled PDU 470 may be three. The PDCP layer unit 440 may read the LI1 field 340 to obtain a length of a first PDCP SDU, and may read the LI2 field 350 to obtain a length of a second PDCP SDU. The PDCP layer unit 440 may read data from octet 7 to a location corresponding to the length of the first PDCP SDU, and may separate the data corresponding to the length of the first PDCP SDU to obtain a first separated SDU 480. The obtained first separated SDU 480 may be transmitted to the Layer 3 450. The PDCP layer unit 440 may read data from a location corresponding ‘octet 7+value in LI1 field’ to a location corresponding to the length of the second PDCP SDU, and may separate the data corresponding to the length of the second PDCP SDU to obtain a second separated SDU 480. The obtained second separated SDU 480 may be transmitted to the Layer 3 450. A third PDCP SDU may be obtained by reading data from a location corresponding to ‘octet 7+value in LI1 field+value in LI2 field’ The total size of the PDU may be determined based on the size of the SDU of the sublayer, the third PDCP SDU may be data from the location corresponding to the octet 7+value in LI1 field+value in LI2 field’ to the end of the PDU. The third separated SDU 480 may also be transmitted to the Layer 3 450.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. An enhanced communication apparatus, the apparatus comprising:
a Packet Data Convergence Protocol (PDCP) layer unit to concatenate a plurality of Packet Data Convergence Protocol Service Data Units (PDCP SDUs) to generate at least one PDCP PDU; and
a Radio Link Control (RLC) layer unit to concatenate or segment the at least one Packet Data Convergence Protocol Packet Data Unit (PDCP PDU) received from the PDCP layer unit.

2. The apparatus of claim 1, wherein the PDCP layer unit concatenates the plurality of PDCP SDUs based on a radio link state to generate the at least one PDCP PDU.

3. The apparatus of claim 2, wherein the PDCP layer unit receives, from a medium access control (MAC) layer unit, information associated with the radio link state.

4. The apparatus of claim 1, wherein the PDCP layer unit concatenates the plurality of PDCP SDUs based on a transmission period of an MAC layer unit.

5. The apparatus of claim 1, wherein the PDCP PDU includes, subsequent to octet including a Packet Data Convergence Protocol Sequence Number (PDCP SN) field, a field indicating a length of each PDCP SDU, and a bit indicating whether each PDCP SDU of the concatenated plurality of PDCP SDUs has a subsequently concatenated PDCP SDU.

6. The apparatus of claim 5, wherein the PDCP PDU includes, in a fourth bit of octet 1, a bit indicating whether the concatenated plurality of PDCP SDUs exists.

7. An enhanced communication apparatus, the apparatus comprising:
an RLC layer unit to reassemble a plurality of PDUs received from a Physical Layer (PHY) to generate at least one reassembled PDU; and
a PDCP layer unit to separate the at least one reassembled PDU received from the RLC layer unit.

8. The apparatus of claim 7, wherein the reassembled PDU includes, subsequent to octet including a PDCP SN field, a field indicating a length of each PDCP SDU, and a bit indicating whether each PDCP SDU of a concatenated plurality of PDCP SDUs has a subsequently concatenated PDCP SDU.

9. The apparatus of claim 8, wherein the reassembled PDU includes, in a fourth bit of octet 1, a bit indicating whether the concatenated plurality of PDCP SDUs exists.

10. The apparatus of claim 9, wherein the PDCP layer unit separates the reassembled PDU based on the bit indicating whether each PDCP SDU of the concatenated plurality of PDCP SDUs has the subsequently concatenated PDCP SDU, the field indicating the length of each PDCP SDU, and the bit indicating whether the concatenated plurality of PDCP SDUs exists.
